(19) United States
(12) Patent Application Publication
(10) Pub. No.: US 2014/0377035 A9
(43) Pub. Date: Dec. 25, 2014

(54) PHOSPHATED SCREW

(71) Applicant: Thorsten Schraer, Gerolsbach (DE)

(72) Inventor: Thorsten Schraer, Gerolsbach (DE)

(73) Assignee: Ruia Global Fasteners AG, Neuss (DE)

(21) Appl. No.: 13/984,358

(22) PCT Filed: Jan. 30, 2012
(86) PCT No.: PCT/DE2012/200005

§ 371 Date: Aug. 8, 2013

(30) Foreign Application Priority Data
Feb. 9, 2011 (DE) 20 2011 002 554.3

(51) Int. Cl. F16B 33/00; C23C 28/04; C23C 22/83

(52) U.S. Cl. CPC F16B 33/00; C23C 22/83; C23C 28/04
USPC 411/424

(57) ABSTRACT

Phosphated screw which after phosphating is provided with a siliceous sealing layer and has been rolled only after phosphating and after application of the siliceous sealing layer.

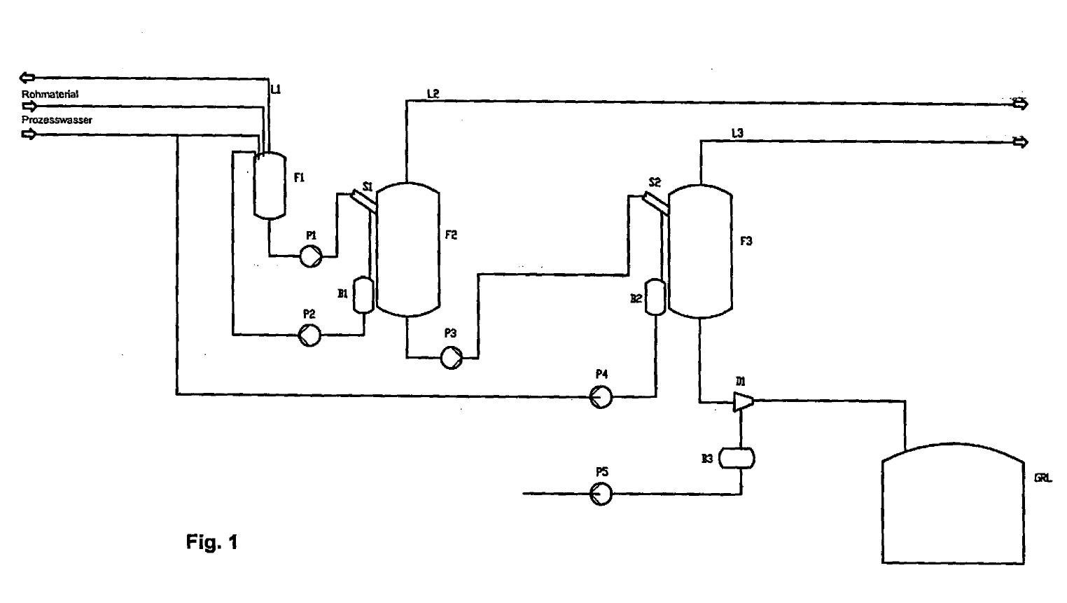

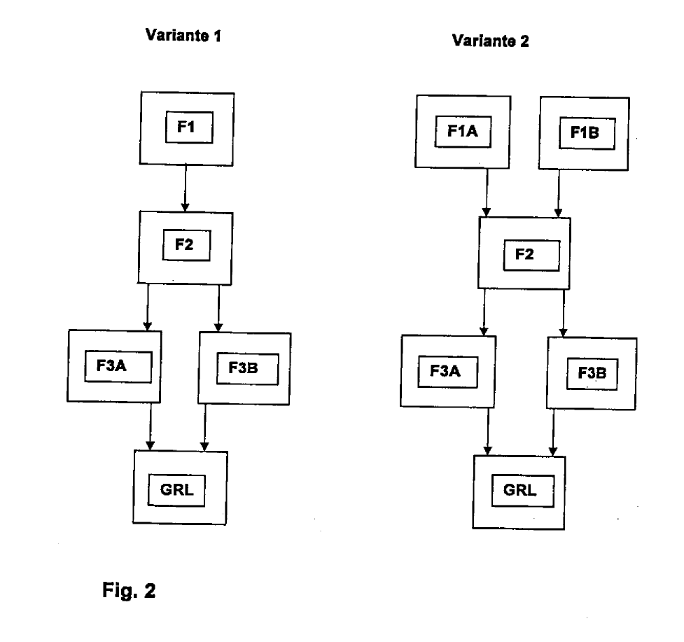

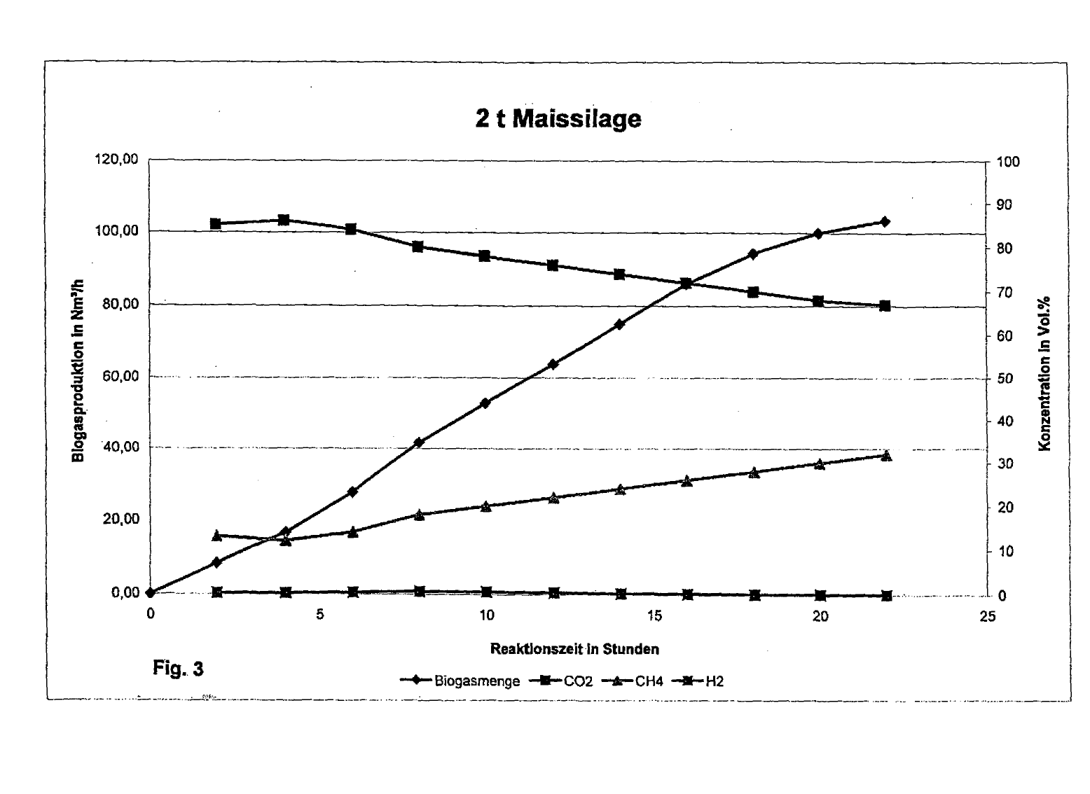

### FIELD OF THE INVENTION

The present invention relates to a phosphated screw.

### PRIOR ART

Currently in the motor industry, all internal engine screws are phosphated and subsequently oiled in order to maintain a certain resistance to corrosion and a defined coefficient of friction in accordance with OEM and German automobile industry standards. This creates the problem that the necessary oiling renders the screws so oily that oil residues collect in the transport packaging, which must be cleaned before being returned. In addition, the excess oil dirties the automatic assembly systems. These systems must then be cleaned frequently, resulting in the system having to remain idle unnecessarily. The application of oil also causes any dirt or debris which comes into contact with the screws to adhere thereto. In the case of large foreign bodies, this can lead to incorrect screw-fitting.

### DESCRIPTION OF THE INVENTION

Based on this prior art, the object of the present invention is therefore that of creating phosphated screws which do not require oiling, and which nevertheless have the necessary resistance to corrosion and in particular the predetermined coefficient of friction.

Previous attempts to solve this problem have involved providing screws with solid film lubricants and the like. Solid film lubricants, however, have the disadvantage that they are either too thick, produce too much abrasion or are not sufficiently resistant to pressure.

Different oil blends were also tried, but these too gave unsatisfactory results.

According to the invention, the above-mentioned object will be solved for the first time by providing the phosphated screw with a siliceous sealing after phosphating.

It is particularly preferable in this case to roll the screw only after phosphating and the application of the siliceous sealing. This pushes the phosphate flakes into the thread flanks, where they influence the coefficient of friction. This can also be done with silicate.

### BEST MODE FOR CARRYING OUT THE INVENTION

The present invention suggests for the first time providing phosphated screws with siliceous sealings, for example the product Delta-Protekt® VH301 GZ from the company Darken MKS-Systeme GmbH Si. Co. KG, Herdecke or the product Plus® VL PLS0218 from the company Dacral S.A., Creil, France. Such siliceous sealings have previously only been used on zinc flake surfaces; they have not previously been used on the phosphate layer of a phosphated screw in order to increase corrosion protection and to achieve a defined coefficient of friction.

The siliceous sealings preferred in this case are composed either of an aqueous solution of 55 to 65% silicon dioxide, 35 to 41% lithium oxide and 0.5 to 2% 2-butoxyethanol, ethyl carbinol as a solvent and lithium hydroxide, or of an aqueous solution of 73% of the sodium salt of silicic acid, that is, of sodium silicate, with 14 to 19% acrylic resin and 10 to 11% polytetrafluoroethylene (PTFE).

The advantage of the present invention is that said invention has made it possible for the first time for a pressure- and abrasion-resistant dry lubricating film having just a very thin layer to be obtained on phosphated screws.

Due to the hardness of the siliceous sealing, it is possible according to the invention to achieve particularly favourable frictional properties, the screws preferably being rolled only after phosphating and the application of the siliceous sealing.

Later rolling pushes phosphate flakes in particular into the thread flanks and has a positive influence on the frictional properties at this location. The same occurs with silicate.

1. A phosphated screw characterised in that the screw is provided with a siliceous sealing after phosphating.

2. The phosphated screw according to claim 1, characterised in that the screw is rolled only after phosphating and the application of the siliceous sealing.
